(19) United States
(12) Patent Application Publication
(10) Pub. No.: US 2004/0002314 A1
(43) Pub. Date: Jan. 1, 2004

(54) Integrating apparatus

(75) Inventors: Tsung Hsien Tsai, Taoyuan City (TW); Chia-Yin Yang, Taoyuan City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Prolific Technology, Inc., Taipei (TW)

(21) Appl. No.: 10/418,497

(22) Filed: Apr. 18, 2003

(30) Foreign Application Priority Data
Apr. 19, 2002 (TW) 091205368

(51) Int. Cl. H04B 1/06

(52) U.S. Cl. 455/253.2; 455/234.1

(57) ABSTRACT

An integrating apparatus is provided, which includes a power supply for providing a power to be the main power of the integrating apparatus, a controller connected electrically with the power supply so as to control the operation of the integrating apparatus, a storage device connected electrically with the controller for storing a data, and at least a transmitting interface connected with at least a 3C equipment so that the 3C equipment transmits the data through the transmitting interface.

### FIELD OF THE INVENTION

The present invention relates to an integrating apparatus having 3C integrating functions, and more particularly to an apparatus having 3C integrating functions applied to a cell phone.

### BACKGROUND OF THE INVENTION

For the general consumers, the 3C products have become the essential goods. The 3C products are the computers, communication products and consumer electronics applicances. In the past, these 3C products are independently operated. Recently, because the science and technology progress rapidly and the related integrating technology tends to unification, more and more 3C products are allowed to transmit data to each other. The higher compatibility of the data transmitting form not only accelerates the transmitting speed, but also increases the convenience for data processing. Thus, the integrating apparatus developed according to the above frame are more practical and would satisfy the consumers' needs for high-tech. products. In addition, through connecting this frame, the integrating apparatus developed from different 3C products can obtain the higher expansion and the better efficiency.

Further, since a mobile phone is improved from the 2G (GSM), the 2.5G (GPRS and EDGE) to the 3G (WCDMA and CDMA2000), the bandwidth is increased and the data download speed is faster. However, the mobile phone is limited by its memory capacity so that it cannot store a large number of data immediately (the types of the data can be the music, words, images, pictures, etc.).

In view of foregoing reasons, the present invention provides the integrating apparatus for solving the problems mentioned above and the integrating apparatus is especially applied to a mobile phone.

### SUMMARY OF THE INVENTION

It is an object of the present invention to provide an integrating apparatus, especially an integrating apparatus having 3C intergrating functions for a mobile phone. The music data, the image data, the sound data and the picture data of the mobile phone are able to be downloaded to the provided integrating apparatus and then stored or broadcasted. Similarly, the foregoing data are able to be uploaded to the integrating apparatus from the mobile phone.

It is another object of the present invention to provide an integrating apparatus have 3C integrating functions, which has the function of recording sounds of a mobile phone so that the communication contents are recorded.

It is another object of the present invention to provide an integrating apparatus applied to a mobile phone, which has the function of auto-answering so as to automatically answer a phone call and record a message when the phone call is not answered by the communication apparatus.

According to one aspect of the present invention, an integrating apparatus includes: a power supply, a controller electrically connected with the power supply for controlling the apparatus, a storage device electrically connected with the controller for storing a data, and at least a transmitting interface electrically connected with at least a 3C equipment so that the at least a 3C equipment transmits the data through the transmitting interface.

Preferably, the 3C equipment is a communication apparatus.

Preferably, the communication apparatus is a cell phone.

Preferably, the apparatus further includes an external storage medium for increasing a storing capacity of the apparatus.

Preferably, the apparatus further includes a digital analogy changer (DAC) for transforming the data from a digital signal to an analogical signal.

Preferably, the apparatus further includes a sound broadcasting module for transforming the analogical signal into a sound and outputting the sound.

Preferably, the apparatus further includes a display for transforming and outputting the data stored in the storage so as to display the data.

Preferably, the apparatus further includes a decoder for transforming a type of the data.

Preferably, the type of data is a music data with different type.

Preferably, the apparatus further includes an analogical digital changer (ADC) for transforming the data from an analog signal to a digital signal and storing the digital signal in the storage device.

Preferably, the ADC is a sound recording module.

Preferably, the apparatus further includes a print port for being connected to a printer.

Preferably, the controller controls the storage device, the DAC and the sound broadcasting module to be an automatic answering module for providing a function of auto answering so as to automatically answer a phone call and record a message when the phone call is not answered by the communication apparatus

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a block diagram of the integrating apparatus according to the first preferred embodiment of the present invention;

FIG. 2 is a block diagram of the integrating apparatus according to the second preferred embodiment of the present invention; and

FIG. 3 is a block diagram of the integrating apparatus according to the third preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

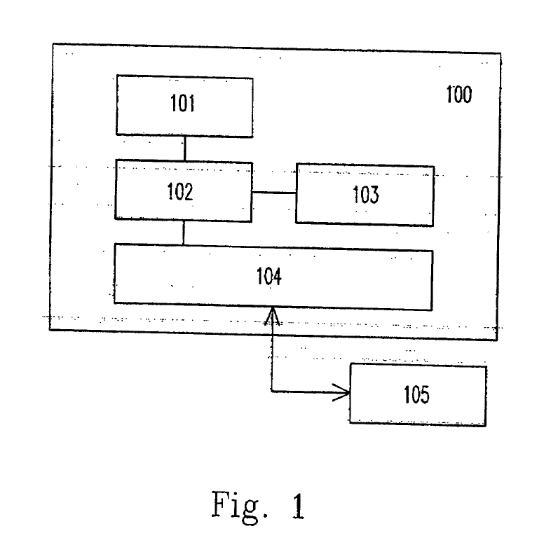

FIG. 1 is a block diagram of the integrating apparatus according to the first preferred embodiment of the present invention. Please refer to FIG. 1. The integrating apparatus 100 includes the power supply 101, the controller 102, the storage device 103 and at least one transmitting interface 104. The power supply 101 provides a power which is the main power of the integrating apparatus 100. The controller 102 is electrically connected with the power supply 101 so as to control the integrating apparatus 100. The storage device 103 is electrically connected with the controller 102 which controls the storage device 103 for storing the data. And, the transmitting interface 104 is connected with at least one of the 3C equipments 105 so that the 3C equipment 105 transmits the data through the transmitting interface 104.

The 3C equipment can be a communication apparatus (ex. A mobile phone) or an informational apparatus (ex. A computer, a PDA, a notebook, etc.).

The data of the 3C equipment 105 can be downloaded to the integrating apparatus 100 through the transmitting interface 104 and then stored in the storage device 103. Similarly, the data can be uploaded from the storage device 103 to the 3C equipment 105. Moreover, the data can be music data, image data, picture data, or text data, etc.

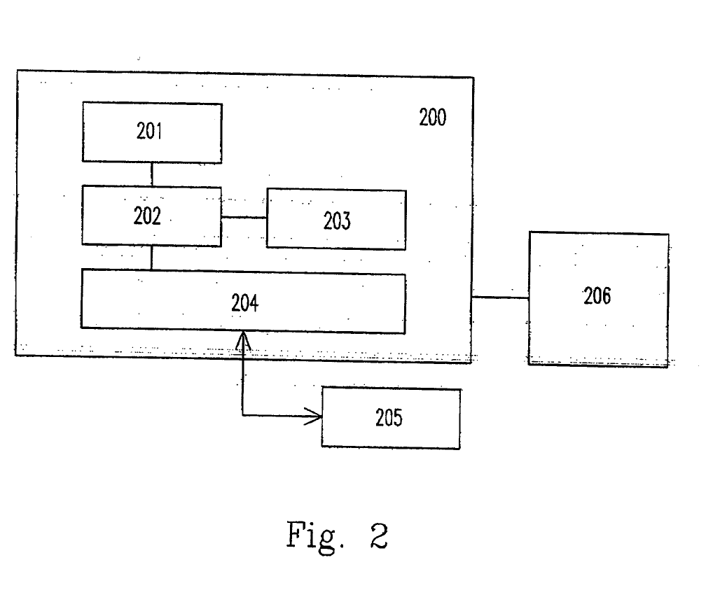

FIG. 2 is a block diagram of the integrating apparatus according to the second preferred embodiment of the present invention. As shown in FIG. 2, an integrating apparatus 200 includes the power supply 201, the controller 202, the storage device 203 and at least one transmitting interface 204. The power supply 201 provides a power which is the main power of the integrating apparatus 200. The controller 202 is electrically connected with the power supply 201 so as to control the integrating apparatus 200. The storage device 203 is electrically connected with the controller 202 which controls the storage device 203 for storing data. And, the transmitting interface 204 is connected with at least one of the 3C equipments 205 so that the 3C equipment 205 transmits the data through the transmitting interface 204. Moreover, the integrating apparatus 200 further includes an external storage medium 206 for increasing the data capacity of the integrating apparatus 200.

Thus, the data of the 3C equipment 205 can be downloaded to the integrating apparatus 200 through the transmitting interface 204 and then stored in the storage device 203. Similarly, the data can be uploaded from the storage device 203 to the 3C equipment 205. When the storage device 203 is full, the external storage medium 206 can be used for storing the data.

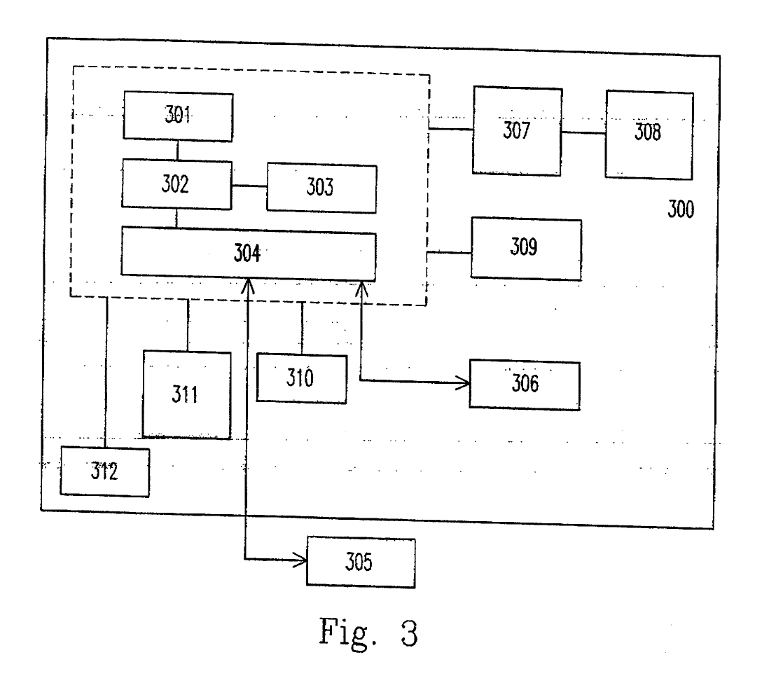

FIG. 3 is a block diagram of the integrating apparatus according to the third preferred embodiment of the present invention. As shown in FIG. 3, an integrating apparatus 300 includes the power supply 301, the controller 302, the storage device 303, at least one transmitting interface 304, the external storage medium 306, the digital analogy changer (DAC) 307, the sound broadcasting module 308, the display 309, the decoder 310, the analogical digital changer (ADC) 311 and the print port 312. The power supply 301 provides a power which is the main power of the integrating apparatus 300. The controller 302 is electrically connected with the power supply 301 so as to control the integrating apparatus 300. The storage device 303 is electrically connected with the controller 302 which controls the storage device 303 for storing data. And, the transmitting interface 304 is connected with at least one of one 3C equipments 305 so that the 3C equipment 305 transmits the data through the transmitting interface 304. The DAC 307 transforms music data from a digital signal to a analogous signal. Through the sound broadcasting module 308, the DAC 307 also transforms the analogical signal into a sound and outputs the sound thereafter.

The display 309 transforms and outputs the data stored in the integrating apparatus 300 so as to display the data. The data can be image data, picture data, or text data, etc.

The integrating apparatus 300 further includes the decoder 310 for transforming a type of the data. The type of the data can be the different music data, for example, MP3, CDA, MID, MIX, MP2, MP1, WAVE, etc. The type of the music data can be transformed by the decoder 310 and stored in the storage device 303, or output through the sound broadcasting module 308.

The ADC 311 is used for transforming the data of the integrating apparatus 300 from an analog signal to a digital signal and storing the digital signal in the storage device 303. The ADC 311 of the present invention can be a sound recording module for providing the users to record the sound.

The print port 312 connects with a printer for printing the data.

The controller 302 controls the storage device 303, the DAC 307 and the sound broadcasting module 308, which form an automatic answering module for providing a function of auto answering so as to automatically answer a phone call and record a message when the phone call is not answered by the communication apparatus.

Therefore, the present invention provides an integrating apparatus for being connected with a mobile phone. The data of the mobile phone can be downloaded to the integrating apparatus or uploaded from the integrating apparatus to the mobile phone. The integrating apparatus is able to be operated independently to broadcast or display the data. When the apparatus is connected with any 3C products, the apparatus can transmit the data to the 3C product and achieve the integrating object. Therefore, the drawbacks of the prior arts can be overcome.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An integrating apparatus, comprising:
a power supply;
a controller electrically connected with said power supply for controlling said apparatus;
a storage device electrically connected with said controller for storing a data; and
at least a transmitting interface electrically connected with at least a 3C equipment so that said at least a 3C equipment transmits said data through said transmitting interface.

2. The apparatus according to claim 1, wherein said 3C equipment is a communication apparatus.

3. The apparatus according to claim 2, wherein said communication apparatus is a cell phone.

4. The apparatus according to claim 1 further comprising an external storage medium for increasing a storing capacity of said apparatus.

5. The apparatus according to claim 1 further comprising a digital analogy changer (DAC) for transforming said data from a digital signal to an analogical signal.

6. The apparatus according to claim 5 further comprising a sound broadcasting module for transforming said analogical signal into a sound and outputting said sound.

7. The apparatus according to claim 1 further comprising a display for transforming and outputting said data stored in said storage so as to display said data.

8. The apparatus according to claim 1 further comprising a decoder for transforming a type of said data.

9. The apparatus according to claim 8, wherein said type of data is a music data with different type.

10. The apparatus according to claim 1 further comprising an analogical digital changer (ADC) for transforming said data from an analog signal to a digital signal and storing said digital signal in said storage device.

11. The apparatus according to claim 10, wherein said ADC is a sound recording module.

12. The apparatus according to claim 1 further comprising a print port for being connected to a printer.

13. The apparatus according to claim 1, wherein said controller controls said storage device, said DAC and said sound broadcasting module to be an automatic answering module for providing a function of auto answering so as to automatically answer a phone call and record a message when said phone call is not answered by said communication apparatus.
